(19) United States
(12) Patent Application Publication
(10) Pub. No.: US 2013/0011303 A1
(43) Pub. Date: Jan. 10, 2013

(54) GAS-COLLECTION-TYPE GAS-LIQUID REACTION DEVICE, AND WATER TREATMENT APPARATUS AND GAS PURIFICATION APPARATUS USING SAME

(76) Inventor: Jong Seop Shim, Gwangju-si (KR)

(21) Appl. No.: 13/635,433

(22) PCT Filed: Aug. 26, 2010
(86) PCT No.: PCT/KR10/05722

§ 371 Date: Sep. 16, 2012

(30) Foreign Application Priority Data
Mar. 15, 2010 (KR) 10-2010-0023042

(51) Int. Cl. B01D 53/86; C02F 1/78

(52) U.S. Cl. 422/168; 210/151

(57) ABSTRACT

The present invention relates to a gas-collection-type gas-liquid reaction device, and to a water treatment apparatus and gas purification apparatus using same. More particularly, the present invention relates to a gas-collection-type gas-liquid reaction device which can reduce the costs, such as installation costs and operation costs, of a water treatment apparatus and gas-cleaning apparatus by improving reaction efficiency through an increase in contact time between a gas and liquid, wherein gas and liquid materials are fed through an upper inlet of the gas-liquid reaction device, and a relatively lightweight gas collected from an upper space of the gas-liquid reaction device can react with a liquid fed and sprayed into an upper portion over a predetermined period of time until the gas is discharged through a lower outlet of the gas-liquid reaction device. The present invention also relates to a water treatment apparatus and gas purification apparatus using the gas-collection-type gas-liquid reaction device.

### TECHNOLOGY OVERVIEW

This invention is related to the gas collecting gas-liquid reactor and the water treatment equipment and gas purification equipment using that reactor, which reduces the costs such as installation cost, operating cost, etc by improving the reaction efficiency. When the gas and liquefied substances are fed into the inlet located at the top, the relatively light weight gas will be collected from the space at the top of the gas-liquid reactor and reacts with the liquid sprayed into the reactor during certain period of time until it is released through the outlet at the bottom of reactor, and the reaction efficiency is improved by extending contact time between the gas and liquid, for which allows cost reduction such as installation, operation, etc.

### BACKGROUND TECHNOLOGIES

The most of existing gas-liquid reactors have a structure of catalytic reaction that the light weighted gas are injected through the bottom of the equipment and the liquid, which are relatively heavy, sprayed to the top and react with the gas going up or the gas are injected to the bottom of the reactor filled with the water contained the pollutants and the gas are released through the top of the reactor

Existing ozone oxidation reactors injects the ozone to the bottom of reactor filled with polluted water using gas mixing equipments such as diffuser, Venturi tube, etc. or use the normal pressure oxidation reactor grafted with DOF (dissolved Ozone Floatation) process, which generates micro- or nano-size of the ozone bubbles allowing them to float and react with the polluted water by supplying the pressurized polluted water through the bottom of oxidation reactor where lots of pressurized ozone are injected to increase the dissolution of ozone.

The FIG. 1 is an example that the existing oxidation reactor is used where the ozone gas are injected in the form of fine bubble to the bottom of reactor contained the pollutants through the diffuser or Venturi tube. This is the typical ozone reactor consuming lots of ozone because the ozone gas, which come out to the surface without reacting with the pollutants, are released through the top, and lots of ozone should be supplied to dissolve the ozone in the water close to the saturated concentration.

In the existing ozone oxidation reactor, if the ozone gas is injected to the bottom of oxidation reactor filled with polluted water, most of the ozone is presented in the form of bubbles due to low solubility of the ozone, and since the bigger the size of bubble is, the shorter the time of staying the ozone bubble in the water, the contact time with the pollutants is getting shorter. For this reason, the oxidation reactor applied with the DOF process, which increase the reaction time by making the ozone in micro or nano-sized bubbles to reduce the floating speed, was developed, and for the ozone oxidation reactor, which injects the ozone gas into the polluted water like DOF process, the size of the ozone bubble is the key factor to determined the efficiency of the oxidation reaction.

Since the ozone injected into the oxidation reactor generally can contact and react with the pollutants only for the time of staying in the water, in case of reaction that injects the ozone into the water, the DOF process which the time to stay in the water was increased by reducing the size of ozone bubble and the speed of floatation, and made the height of oxidation reactor higher, has been improved than the methods using diffuser, Venturi pipe, etc, but it has limitation to increase the size of the oxidation reactor because the bubble size is getting bigger as the ozone bubbles are floating up.

In case of pipe type oxidation reactor, which the oxidation is performed continuously under the pressure, it improved the efficiency than existing ozone oxidation reaction performing oxidation by dissolving lots of ozone in the water proportional to the pressure, but since the ozone over-injected are moving separated to the top of the tube type oxidation reactor due to characteristics of the reaction, which the ozone should be injected more than the dissolved volume to supplement the ozone consumed during the oxidation reaction, it is discharged with treated water without being recycled. To solve this problem, there were the attempts to improve the efficiency of the oxidation reaction by installing the mixing devices such as line mixer, etc in order not to separate the injected ozone from water layer and dissolving the ozone in the gas located at the top of the tube type oxidation reactor according to the progress of the reaction, but there is a limit to make the ozone in the form of fine bubbles in the tube type oxidation reactor, and further, there are lots of ozone without reacting with pollutants due to characteristics of the reactor that the injected ozone is flowing with polluted water along the tube type oxidation reactor and discharged after reaction.

Among the technologies used to increase the efficiency of the existing ozone oxidation reaction technology, the technology using DOF (Dissolved Ozone Floatation) process, which generates and makes the fine bubble of ozone to react in the process of removing the pressure of pressurized polluted water after pressuring and making the ozone gas to react with the polluted water, and the pressurized oxidation reactor, which make the ozone to react with the polluted water by attaching mixing device in order to mix with the polluted water to resolve the problem that the ozone is separated from the gas as it is flowing together with polluted water after injecting the pressurized ozone and polluted water into tube type reactor, were the good technologies.

### DETAILED EXPLANATION OF THE INVENTION

### Technical Problem

To increase the efficiency of existing ozone oxidation reactor, the distance that the fine bubbles are floating, that is, the higher the height of the reactor, the longer the contact time will be increased, but since even for the micro- or nano-sized ozone, they are getting bigger and floating faster as they are joined together, there is limit in making the size of oxidation reactor bigger infinitely to increase the contact time, and since the method that re-injects the ozone to be discharged without reacting, requires separate pumping system to pressurize the ozone and another reactor, and is hardly used due to increase of the costs and inconveniences, existing oxidation reactors consumed lots of ozone because it discomposes and discharge the highly concentrated unused ozone under the environmental threshold.

In addition, in case of duct type reactor, which increased the volume of dissolved ozone by pressurizing ozone and polluted water, the solubility is increase proportional to the pressure, but since the ozone in the gas is separated as they are run the reactor, and there is limit in making the ozone into fine bubbles although recycling of the ozone was attempted by installing the mixing devices such as line mixer, etc to mix the ozone with polluted water at the several places. Therefore, since the ozone gas within the reactor are presented in the form of relatively bigger bubbles and discharged together with polluted water, there is limit to reduce the volume of unused ozone like the size of reactor should be increase to extend the contact time, etc.

In the previous case, since the pressurized polluted water is discharged in the state mixed with ozone gas, if the dissolved ozone floatation (DOE) process is applied as post process, the DOF process should be applied after the gas-liquid device due to problem that the efficiency of DOF process is rapidly decreased because the ozone in the gas forms the big bubbles and the fine bubbles are going up together with the big bubbles without going up their floating speed, etc.

For this reason, existing ozone oxidation reactor has a problem to increase the installation cost and maintenance cost because the existing ozone oxidation reactor has low efficiency using the ozone gas for oxidation reaction and the expensive ozone generator capacity should be increased to supply much more volume of ozone than that required for actual oxidation reaction to obtained the determined efficiency of oxidation reaction.

In addition, since greater volume of unused ozone is discharged, there is problem of increasing the costs by designing the capacity of the expensive ozone generator as much as the unused ozone to be discharged and the capacity of the wasted ozone discomposing device much bigger, etc. when installing the ozone oxidation equipment.

Invented by recognizing the above mentioned problems, the purpose of this invention is to provide the gas collecting gas-liquid reactor, which can maximize the pollutants removal efficiency minimizing volume of unused ozone by performing repeatedly the catalyst reaction with pollutants to resolve the structural problems that the ozone used in ozone oxidation reactor are disposed without being used, and provide the water treatment equipment and gas purification equipment using that reactor.

### Solutions of Problems

To achieve the aforementioned objectives, the gas collecting gas-liquid reactor designed by this invention has long vertical gas collecting space inside and inlet at the top and outlet at the bottom, which are linked with the gas collecting space. Gas and liquid are pressurized and induce to inlet at the top with 1 to 15 atmosphere pressure. This equipment has characteristics that the gas will be collected from top of gas collecting space filling the space toward the bottom in order, and discharged through the outlet at the bottom, and the liquid will be sprayed from inlet at the top performing catalyst reaction in the gas layer collected at the top of the space, and discharge through the outlet at the bottom.

Also, the gas collecting gas-liquid reactor designed by this invention has characteristics that the multiple numbers of above gas-liquid reactor are connected in series or parallel.

Also, the water treatment equipment using the gas collecting gas-liquid reactor designed by this invention includes the gas-liquid reactor, which gas collecting space is formed inside vertically extended from top to bottom and the inlet at the top and outlet at the bottom linked with gas collecting space and the gas-liquid separation device connected to the outlet at the bottom of above gas-liquid reactor, but the gas-liquid reactor pressurizes the gas and liquid with 1 to 15 atmosphere pressure by the booster pump and put through the inlet at the top, and the gas will be collected from top of gas collecting space filling the space toward the bottom in order, and discharged through the outlet at the bottom, and the liquid will be sprayed from inlet at the top performing catalyst reaction in the gas layer collected at the top of the space, and discharge through the outlet at the bottom. The treated water that consists of gas, which is ozone, and the liquid, which is the polluted water contained the pollutants, is designed to be discharged through the outlet at the bottom, The gas-liquid separation device has characteristics to separate the unused ozone gas from the treated water removing the pressure of the pressurized treated water.

And the water treatment equipment using the gas collecting gas-liquid reactor designed by this invention has characteristics that the aforementioned collecting space are filled with filling materials consisted of one or more materials such as the metal, ceramic, high polymer resin.

The water treatment equipment using the gas collecting gas-liquid reactor designed by this invention includes the wasted ozone discomposing device connected to gas-liquid separation device in order to reduce the unused ozone to be discharged and disposed from above gas-liquid separation device. The aforementioned wasted ozone discomposing device is the cylinder type reactor having inlet and outlet, and has characteristics built with quartz tube, in which the ultraviolet lamp is inserted and protected, and the photo-catalyst having major ingredients of ultraviolet charged and titanium dioxide around the aforementioned quartz tube in order to treat the not reacted ozone and pollutants by advanced oxidation process which removes the pollutants by converting not reacted ozone to OH radical and reacting with pollutants.

In addition, the gas purification device using the gas collecting gas-liquid reactor designed by this invention has a gas collecting space formed inside vertically from top to bottom, and the gas purification device using gas-liquid reactor equipped with inlet at the top and outlet at the bottom linked to the above gas collecting space. The gas-liquid reactor pressurizes the gas and liquid with 1 to 15 atmosphere pressure by the booster pump and put through the inlet at the top, and the gas will be collected from top of gas collecting space filling the space toward the bottom in order, and discharged through the outlet at the bottom, and the liquid will be sprayed from inlet at the top performing catalyst reaction in the gas layer collected at the top of the space, and discharge through the outlet at the bottom. The gas, which is the polluted gas contained ozone, and the liquid consists of the purification liquid. It has characteristics that the polluted gas is collected from the top of the space and filled the outlet at the bottom, and the purification liquid is diffused to the polluted gas layer and reacts with the polluted gas falling down and discharged together with the purified gas through the outlet at the bottom.

### EFFECTS OF THE INVENTION

The gas collecting gas-liquid reactor designed by this invention according to the aforementioned construction, and the water treatment equipment and the gas purification equipment using that reactor are the gas-liquid reactor using the characteristics that the light gases are gathered in the top of the gas-liquid reactor due to difference of the density differently from existing oxidation reactor that the gases such as ozone or polluted gas are discharged with the treated water when they are injected into gas-liquid reactor.

In case of the water treatment equipment, for which the injected gas is ozone, it put the ozone and polluted water through the top of the gas-liquid reactor and discharges through the bottom. As the relatively light ozone gas is collected inside of gas-liquid reactor, and the polluted water to be injected is discharged after reacting constantly with the gas collected during certain period of time, it provides the means that the gas injected is dissolved in the polluted water as much as the volume saturated at the pressure of reaction established and the remaining gas is dissolved as much as the volume consumed according to the reaction process. In addition, since the gas injected is collected within the reactor without flowing away with the polluted water, and discharged with the treated water after being reacted constantly with polluted water, it has advantages to increase the reaction efficiency by extending the contact time between gas and polluted water and be able to reduce cost such as installation cost, operating cost, etc by reducing the volume of not reacted gas and the capacity of the wasted ozone discomposing device. Similarly, the gas purification device has advantage to be able to reduce the costs such as installation cost, operating cost, etc by increasing cleaning capacity followed by extending contact time between polluted gas and purification liquid.

In case of existing oxidation reactor, it has the problem that some of the ozone injected are used in oxidation and most of it is disposed as not reacted ozone, but in this invention, effect of cost reduction is great by reducing capacity of expensive ozone generator because reducing the volume of not reacted ozone contained in wasted gas discharged to the atmosphere is as same as increasing efficiency of inject ozone.

In addition, since the gas collecting gas-liquid reactor has a structure to perform reaction with the polluted water constantly collecting the ozone in the gas until it is discharged through the outlet at the bottom, the detention time of ozone, that is, contact time can be adjusted according to the capacity of gas-liquid reactor and the volume of ozone injected, and since the reaction at the normal pressure can be done increasing concentration of ozone by pressurizing reactor, the problems of the existing ozone oxidation reactor such as low reaction efficiency and ozone use can be resolved as it has advantage to increase the efficiency of oxidation as well as minimizing generation of not reacted ozone.

### BRIEF EXPLANATION OF THE DRAWINGS

FIG. 1 is the schematic diagram showing the water treatment equipment using existing ozone oxidation equipment that the light ozone is injected through the bottom and the discharged through the top of the oxidation reactor.

FIG. 2 is the schematic diagram showing gas collecting gas-liquid reactor designed by this invention and the water treatment equipment using that reactor.

FIG. 3 is the schematic diagram showing the gas-liquid reactor installed with various gas collecting gas-liquid reactors.

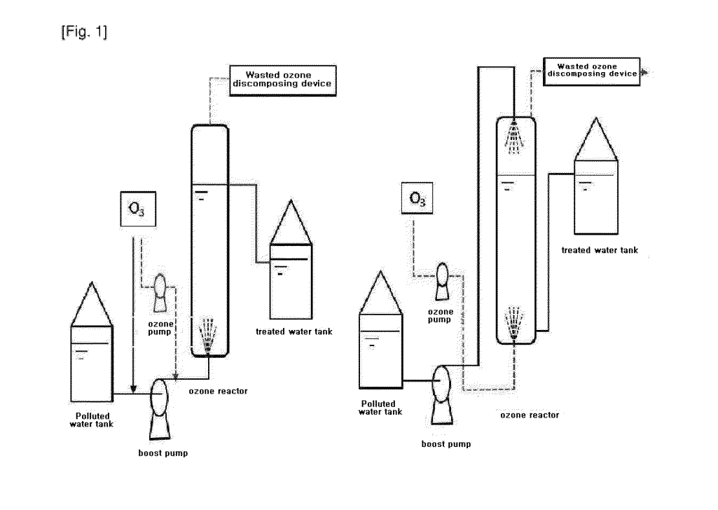

### BRIEF EXPLANATION OF THE MAJOR LEGENDS USED IN DRAWING

10: Polluted water tank 30: Ozone generator

31: ozone gas boost pump 50: boost pump

110: Primary gas collecting gas-liquid reactor

120: Secondary gas collecting gas-liquid reactor

130: Tertiary gas collecting gas-liquid reactor

111, 121, 131: Inlet of the gas collecting gas-liquid reactor

112, 122, 132: Outlet of the gas collecting gas-liquid reactor

113: Level gauge 114: filling material

140: Photo oxidation reactor 150: Circulating pump

160: Flow control valve 170: gas-liquid separator

180: Wasted ozone discomposing device 200: treated water tank

### Method to Implement the Invention

From here, the gas collecting gas-liquid reactor designed by this invention and the water treatment equipment using that reactor shall be explained in detail with the examples shown in drawings.

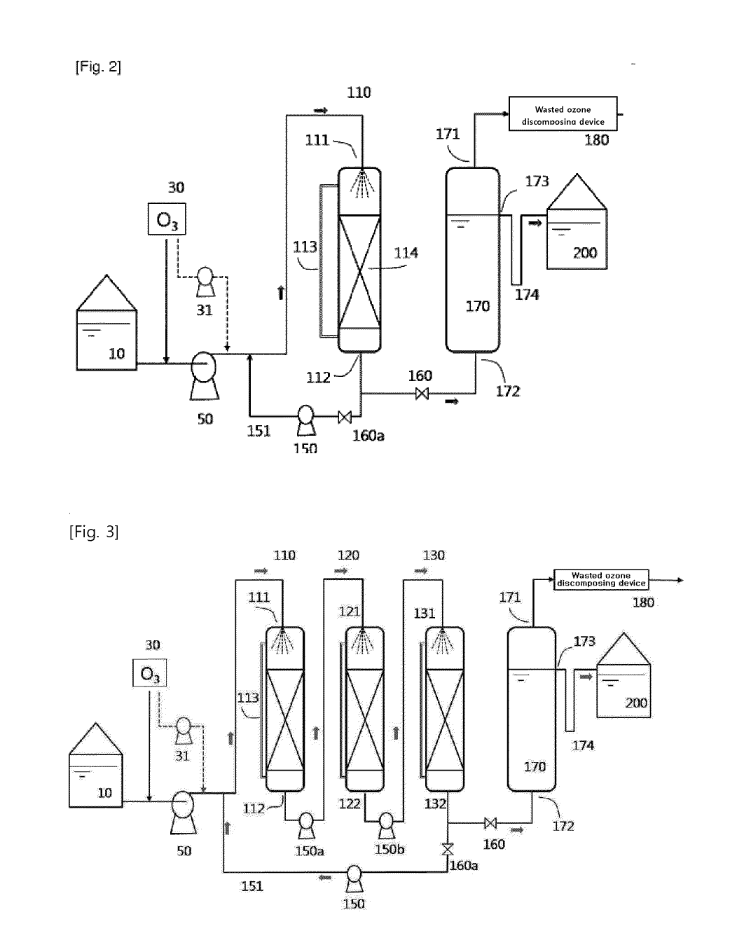

The FIG. 2 is the schematic diagrams showing the gas collecting gas-liquid reactor designed by this invention and the water treatment equipment using that reactor, and the FIG. 3 is the schematic diagram showing the gas-liquid reactor installed with various gas collecting gas-liquid reactors and the water treatment equipment using that.

The gas-liquid reactor (110) designed by this invention has long vertical gas collecting space inside and inlet (111) and outlet (112) linked to above gas collecting space at the top and the bottom, respectively. Gas and liquid are pressurized to 1 to 15 atmosphere pressure with boost pump (50) and injected into the tower type gas-liquid reactor (110) having inlet (111) at the top. The light gas will be collected from top of the gas-liquid reactor and discharged after filling the outlet (112), and the liquid will be sprayed from inlet (111), and discharged through the outlet (112) at the bottom of the gas-liquid reactor (110) after performing catalyst reaction in the gas layer collected at the top of the space.

The gas collecting gas-liquid reactor having aforementioned characteristics is used as water treatment equipment and the gas purification. That is, if the gas is ozone and the liquid is the polluted water contained the pollutants, it shall be used as gas collecting gas-liquid reactor, and if the gas is the polluted gas contained the pollutants and the liquid is purification liquid, the gas collecting gas-liquid reactor will be used as gas purification equipment. The drawing is showing the example that the gas collecting gas-liquid reactor is used as water treatment equipment.

Generally, since the ozone reacts with the pollutants dissolved in the water in the dissolved state by be dissolved in the water rather than reacting with the pollutants dissolved in the water in the state of gas, to increase the oxidation efficiency, the structure of the reactor to increase the volume of dissolved ozone in the polluted water, and to dissolve the ozone in gas easily in the water if the dissolved ozone is consumed by reacting with the pollutants is important factor. Therefore, this invention is intended to provide the ozone oxidation reactor to meet the aforementioned two factors.

This invention is related to the ozone gas collecting gas-liquid reactor that not only can provide the means to dissolve the ozone in gas remained after being dissolved in saturated concentration easily in the water again as much as the volume consumed according to the progress of the reaction, and can increase the ozone oxidation efficiency by increasing the volume of the dissolved ozone discharging the used ozone with the polluted water after being collected inside of reactor without flowing away with the polluted water and being consumed reacting with pollutants constantly during certain period of time, but also can reduce the costs by reducing the capacity of the ozone generator and wasted ozone discomposing device by reducing the volume of not reacted ozone.

Existing ozone oxidation reactor and the gas purification equipment are similar in the aspect that the substance in gas is mainly injected through the bottom and discharged through the top because the gas is lighter than liquid, and the heavy liquefied substance is injected through the top and discharged through the bottom, but they are different in the aspect that in the gas purification equipment, the volume of gas injected is relatively greater than the liquefied substances, and the substance in gas is purified circulating the liquefied substance repeatedly by simple operation of the circulating pump while the volume of ozone gas injected is relatively small than the polluted water and the liquefied substance is purified after injecting ozone into the polluted water and reacting with pollutants and the not reacted ozone is discharged through the top or collected, discomposed and disposed.

The method, which ozone gas is injected in the form of bubble through the bottom of ozone oxidation equipment and discharged after reacting with pollutants floating in the polluted water, is hard to control the frequency of contact with pollutant, and the efficiency of ozone use is very low because it is hard to reuse the ozone collected at the top of the oxidation reactor.

To resolve these problems, this invention constructs the gas-liquid reactor having structure that the ozone gas is injected together with polluted water through the inlet (111) at the top of the gas-liquid reactor (110) and in the beginning stage, only the polluted water is discharged through the outlet (112) at the bottom of gas-liquid reactor (110) and when the ozone gas is filled the outlet (112) at the bottom of the gas-liquid reactor (110), in the same concept that in the gas purification equipment, the pollutants contained in the gas are eliminated as the liquefied substance is circulated repeatedly.

The gas liquid reactor is made that the relatively light ozone gas is stuck from the inlet (111) at the gas-liquid reactor (110) and gradually collected according to the progress of reaction time to the outlet (112) at the bottom, and only the polluted water is discharged through the outlet (112) until the ozone gas would fill the outlet (112) at the bottom of gas-liquid reactor (110)

In the meantime, since the polluted water injected through the inlet (111) at the top reacts with the ozone gas flowing down in the form of droplet or water screen formed on the surface of the filling materials (114) in the collecting space within the gas-liquid reactor(110), and discharged through the outlet (112) at the bottom of the gas-liquid reactor (110), the ozone gas perform catalyst reaction repeatedly by the polluted water until it is discharged from the gas-liquid reactor (110)

Since the ozone gas injected into the aforementioned gas-liquid reactor (110) are stuck inside of the reactor and reacts constantly with the pollutants in the polluted water flowed in until it is discharged through the outlet (112) located at the bottom, its concentration becomes relatively lower by consuming ozone than that located at the top of the gas-liquid reactor (110) as the lower it flows down to the bottom of the gas-liquid reactor (110), the more the frequency of contact is increased.

The gas collecting gas-liquid reactor (110) designed by this invention is related to the gas collecting gas-liquid reactor (110), which can reduce installation cost and maintenance cost by building compact ozone oxidation system with the increased oxidation efficiency obtained by reducing the capacity of ozone generator and the wasted ozone discomposing device (180) by maximizing the oxidation efficiency and minimizing the generation of not reacted ozone by designing the ozone injected to react with the pollutants repeatedly, and related to the water treatment equipment using that.

The ozone gas, which is relatively light and small volume than polluted water, is stuck at the top of the gas-liquid reactor (110), and the ozone injected first is pushed down to the bottom leaving the newly injected ozone at the top. The polluted water consumes the ozone by passing through the ozone gas layer and reacting with ozone, and only the ozone exceeded the capacity of aforementioned gas-liquid reactor (110) is discharged through the outlet (112) at the bottom.

That is, the highly concentrated ozone is located at top due to low frequency of contact, and the lower to the bottom, the lower concentration of ozone is positioned because of the increased ozone consumption by relatively high frequency of contact. Since the closer to the bottom, the frequency of contact with the pollutants is increase, the bigger the size of the gas-liquid reactor (110) is, the time that the ozone is staying in the gas-liquid reactor is increase. If the detention time is increased, it can make all the ozone injected to react by increasing frequency of contact with pollutant. Therefore, it has advantage to control the detention time of ozone, that is, the time to participate in the reaction with the method of deploying the gas-liquid reactor (110) or capacity and volume of ozone injected.

In other words, the concentration of the ozone discharged through the outlet (112) is decreased by be consumed reacting with pollutants repeatedly as the ozone gas injected into the top of the gas-liquid reactor (110) is going down to the bottom of the gas-liquid reactor (110). Since using these characteristics, the ozone gas to be discharged after reaction in the oxidation reactor can be utilized close to 100% by adjusting the capacity of the oxidation reactor and the volume of polluted water injected, it can reduce considerable volume of not reacted ozone to be discharged comparing with the less than 10-30% of utilization in the existing ozone oxidation equipments

The gas-liquid reactor designed by this invention (110) is the ozone oxidation reactor that uses the ozone gas with high efficiency minimizing the not reacted ozone gas by making the ozone gas to contact with polluted water repeatedly like the gas purification equipment that purifies the polluted gas removing pollutants by injecting purification solution repeatedly into the polluted gas

In the meaning of proceeding oxidation by collecting ozone gas in the reactor, this gas-liquid reactor (110) is named as ozone gas collecting gas-liquid reactor (110)

While the ozone gas injected into the top of the gas collecting gas-liquid reactor (110) stays within the gas-liquid reactor (110) filling the top and the bottom of the gas-liquid reactor (110) until it is discharged through the outlet (112) at the bottom, it has advantage to reduce the not reacted ozone by improving the reaction efficiency innovatively because the polluted water is charged can be built in the form that it is discharged through the outlet (112) at the bottom reacting with ozone gas going from the top to bottom of the gas-liquid reactor or the polluted water is circulated to the inlets (121, 131) of the secondary and tertiary ozone gas collecting gas-liquid reactors (120, 130) by the polluted water circulating pump allowing the polluted water to react again by sending back to previous stage of the gas-liquid reactor and repeatedly react the ozone gas collected within the gas-liquid reactors (110, 120, 130)

If the concentration of the ozone discharged through the outlet (112) at the bottom of the gas-liquid reactor is high, the ozone oxidation efficiency can be increased by adjusting the height and diameter of the reactor to increase the space of the reactor and increase the detention time of ozone gas or by connecting the reactors in series to make multiple reaction

Since the filling material is charged in the gas collecting space of the aforementioned gas-liquid reactors (110, 120, 130), the polluted water is flowing down forming water screen providing the surface area to the ozone enough to contact with polluted water, for which the reaction efficiency can be increased.

If the filling materials (114) having small pore space is charged in the gas collecting space of the aforementioned gas-liquid reactor, since the ozone is discharged through the outlet because the volume of filling material is occupied the space within the gas-liquid reactor (110) making the volume of ozone collected smaller and cutting the detention time, the oxidation efficiency can be reduced without achieving the goal to increase the oxidation efficiency than the effects of filling materials to improve the surface area for reaction and dispersibility.

The filling material (114) charged in the in the aforementioned gas-liquid reactors (110) disperses the polluted water not to flow concentrated in the gas-liquid reactor (110), and makes reaction easy with the surrounding ozone gas by forming thin membrane on the surface of the filling material (114) and increasing the surface area as much as the surface area of the filling material (114). As a result, as the more the surface area of the filling material, the surface area is increased, the oxidation efficiency can be varied by changing the surface area according to the type and the shape of the filling material (114).

The metal titanium, stainless steel or ceramic is suitable for the filling material, which is not corroded by polluted water and ozone gas, and the high polymer resin is used in the general gas purification equipments but since it can be deteriorated if it is exposed to the ozone gas, which has strong oxidation power, for extended period of time, the fluoride resin of Teflon system, which is known as stable for the ozone gas, are appropriate.

If the aforementioned filling material in charged within the gas-liquid reactor (11), since the space between the filling materials, that is, the volume of voids is equal to the volume of ozone gas to be collected in the gas-liquid reactor (110), the filling material having high porosity should be used to increase the volume of ozone gas collection in the gas-liquid reactor (110).

In addition, since depending on the shape of the filling material (114), the surface area is varied, it is better using the shape having wider surface area. If the filling material processed in the shape of cylinder type spring is used, the porosity is very high as more than 80% and reaction surface area becomes wider.

In case that the filling material (114) processed in the shape of cylinder type spring is charged in the gas-liquid reactor (110), as it has a effect to hold each other by the elasticity of the spring possessed by individual filling material, it has effect of fixing filling material (114) firmly.

If the multiple of the gas collecting gas-liquid reactors (110) are installed in series as shown in FIG. 3, the volume of not reacted ozone can be minimized by making the polluted water to react with the ozone gas repeatedly by sending polluted water discharged through the outlet (112) at the bottom of the gas-liquid reactor (110) together with the ozone gas to the inlet (121) of the secondary the gas-liquid reactor by the circulating pump (150a), and sending back to tertiary the gas-liquid reactor (130) by same way

Since in this invention, the reaction can be made in the atmosphere pressure higher than normal pressure by pressurizing the aforementioned gas-liquid reactor (110) using boost pump (50) and the valve (160) of the outlet (112) connected to inlet (111) of the gas collecting oxidation equipment, it has considerable better oxidation effect because the reaction can be made in the state of increased volume of dissolved ozone as much as the increased pressure according to the Henry's law as same way as normal pressure.

Since the ozone concentration is getting lowered as the ozone injected first into the inlet (111) at the top of the gas collecting gas-liquid reactor (110) is going toward the bottom because it contacts with polluted water as it is gradually pushed down to the bottom, the concentration of the ozone is lowered relatively than the concentration of the ozone positioned at the top, and if the concentration of the ozone discharged through the outlet (112) at the bottom is high, the ozone oxidation efficiency can be increase reducing the volume of not reacted ozone by adjusting the height and diameter of the aforementioned gas-liquid reactor to increase the space of the gas-liquid reactor (110) and increase the contact time of ozone gas with the polluted water in the ozone gas collecting gas-liquid reactor (110) or by installing various gas-liquid reactors (110) in series to increase the contact time between the ozone gas and polluted water.

In such perspectives, the problem of generating excessive volume of not reacted ozone in existing ozone oxidation equipment can be solved with the advantage of this invention that makes all the ozone injected to react by the characteristics which adjust the capacity of the gas-liquid reactor (110) and the contact time between ozone and polluted water according to the volume of ozone injected.

In this invention, if the several units of the ozone gas collecting gas-liquid reactor (110) are installed as shown in FIG. 3, the ozone discharged through the bottom of the primary reactor can be transferred naturally to the inlet (121) of the secondary gas-liquid reactor (120) together with the polluted water transferred by boost pump (50), and the ozone gas also can be transferred by the polluted water, which is transferred by boost pump (50) without separate circulating pumps (150a, 150b) between the each gas-liquid reactor (110, 120, 130). In this case, since as the pressure is applied naturally to the gas-liquid reactor (110), the volume of dissolved ozone is increased in the polluted water and can react with the ozone gas in the pressurized state, the ozone oxidation system can be made in compact and reduce the installation cost and operating cost by increasing the oxidation efficiency much more allowing pollutants removal efficiency to be increased.

Like the aforementioned case, if the various units of the ozone gas-liquid reactor (110) are installed and operated only with boost pump (50), oxidation efficiency can be increased since the oxidation system can be operated by being pressurized naturally, and the reaction can be operated by adjusting the discharge valve of the outlet (112) at the bottom of ozone gas collecting gas-liquid reactor (110) to set the pressure of the oxidation system freely, that is, by increasing the concentration of the dissolved ozone in the polluted water.

And since the volume of not reacted ozone is generated very small, it has advantage not to install separate wasted ozone discomposing device (180) to discompose the or minimize the size if installing that.

And if the ozone gas and polluted water are reacted by pressurizing by 1˜15 atmosphere pressure in the gas-liquid reactor (110), since the ozone gas injected is dissolved proportional to the pressure, DOF process, which makes the not reacted ozone gas dissolved in the water to react with the not reacted pollutants in the treated water as the not reacted ozone gas is floating up in the micro- or nano-meter size, can be applied.

In addition, the advanced oxidation process, which the pollutants are discomposed by the hydroxy radical generated by the not reacted ozone, ultraviolet and the photo-catalyst as the treated water is passing through the photo-catalysts by installing on the pipeline connecting the outlet (112) of the gas-liquid reactor tube reactor (11) and the inlet (172) of the gas-liquid separator to reduce the volume of not reacted ozone and the not reacted pollutants discharged through the outlet (171) of the aforementioned gas-liquid reactor and disposed or to increase the discomposition rate of the pollutants, but install the tube reactor filled with photo-catalyst having titanium dioxide as the major ingredient in the space between the quartz tube, in which the ultraviolet lamp transmitting UV-C or UV of all wave bands is inserted and protected, can be grafted. Since the aforementioned hydroxy radical has much stronger oxidation power than ozone, it has characteristics to discompose the non-biodegradable pollutants effectively, which is not discomposed well by the ozone.

The ozone gas collecting gas-liquid reactor (110) designed by this invention has a shape of cylinder type reactor having the inlet (111), through which the ozone and the wastes water contained the pollutants are injected, at the top, and the outlet (112), through which the treated water and the gas contained the not reacted ozone are discharged, at the bottom. The inside of aforementioned gas-liquid reactor (110) is empty or the filling material is charged on the filling material supporting table, which prevent the filling material coming out, at the aforementioned gas-liquid reactor. The filling material (114) should be made of ceramic, stainless steel, the metal like titanium, which are not oxidized by the ozone gas and not corroded by the pollutants, etc, or what has porosity to minimize the pressure loss and can maintain wide surface area as the fluoric resin.

The form of aforementioned filling material has high porosity and can maintain the surface area widely if the laminated one layer or more screen having 1 mm or more of the mesh of the net or the spring made in the form of cylinder with 1˜10 mm wire is used, the porosity is very high and the surface area can be maintained widely, and it has advantage to fix the filling material (114) easily inside of the gas-liquid reactor.

For the booster pump (50) connected to the top of the aforementioned gas-liquid reactor, the piston pump, procon pump, centrifugal pump or Wasco pump is fine but if the pumps having absolving power is used, as it can inject the ozone gas with the water into the absorbing end (50a), which provides the advantage not to pressurize the ozone separately, it is convenient to construct the gas-liquid reactor (110)

Although the pumps without absorbing power can inject the small volume of ozone with the polluted water to the absorbing end (50a), if the volume of ozone is big, since it has problem to operate the pump, the ozone gas and polluted water are injected to the posterior end (50b) of the booster pump (50) or it is possible to inject the ozone gas and the polluted water to the posterior end of booster pump using piston pump or procon pump having absorbing power with small capacity.

If the manometer is installed at the side of the aforementioned gas-liquid reactor (110), it help to check the results of oxidation progress because it allows verifying the volume of ozone gas collection inside of gas-liquid reactor (110).

If the flow control valve (160), which adjusts the flow to be discharged, is installed at the outlet (112) at the bottom of the aforementioned gas-liquid reactor (110), the flow control is possible, and if the pressure of the aforementioned gas-liquid reactor (110) is set to the inverter for motor's revolution control of the booster pump (50), the reaction shall be performed maintaining the pressure of the gas-liquid reactor (110) by the control of pump's revolution although the volume to be discharged is changed by the manipulation of flow control valve.

In addition, in case that the more than one gas-liquid reactor (110) are installed in series, it is possible to operate adjusting the pressure applied to individual gas-liquid reactor (110) constantly by installing inline pump (150a, 150b) between each gas-liquid reactor (110), and if one booster pump (50) is being operated, it is possible to operate in a way that the pressure is increased the closer to the posterior end of each gas-liquid reactor (110).

Connect the flow control valve (160) at the farthest end of the aforementioned gas-liquid reactor (110) to the inlet (172) of the gas-liquid separator (170) in order for the treated water to be separated into the wasted gas contained the not reacted ozone gas and the treated water through the gas-liquid separator (170), and be transferred to the storage container or the concentration of the pollutants in the polluted water is adjusted by sending back to the inlet (111) of the aforementioned gas-liquid reactor (110) by circulating pump (150).

In the aforementioned gas-liquid separator, if the reaction is made under the pressure more than normal pressure in the gas-liquid reactor, the not reacted ozone can be reacted with remaining pollutants in the treated water by the DOF process, which the not reacted ozone becomes the fine bubble and floating up.

And if it is required to eliminate the suspended matters in the polluted water, DOF process can be applied effectively by injecting some parts of treated water pressurized with pre-processing reactor having purpose of eliminating suspended matters contained in the polluted water by separating ozone gas over-injected in order not to cause the problem that lowers the DOF process efficiency by injecting the not reacted ozone in gas in the form of big bubble and floating faster than the floating speed of fine bubble, by installing separate gas-liquid separator at the front end of the aforementioned gas-liquid separator (170) in order to inject only the treated water in the pressurized state dissolved the not reacted ozone to polluted water storage (10) or to the bottom of the separate pre-processing reactor.

In addition, if it is required to eliminate the suspended matters in the polluted water, separate the not reacted ozone and the treated water in order not to cause the problem that lowers the DOF process efficiency by injecting the not reacted ozone in gas in the form of big bubble and floating faster than the floating speed of fine bubble by installing separate gas-liquid separator at the front end of the aforementioned gas-liquid separator (170). Inject only the treated water in the pressurized state dissolved the not reacted ozone to the polluted water storage (10) or to the bottom of the separate pre-processing reactor so that the micro- or nano-sized fine bubbles can react with the pollutants in the polluted water or DOF process can be applied effectively for the purpose of attaching, floating and elimination the suspended matters.

At the bottom of the aforementioned gas-liquid separator (170), the inlet (111) for the treated water, through which the not reacted ozone and treated water are flowed in, is installed and at the side close to top of the aforementioned gas-liquid separator (170), the outlet (173) for the treated water to be discharged is located. At the top of the aforementioned gas-liquid separator, the wasted ozone outlet (171), where the not reacted ozone is discharged, is installed, and the wasted ozone discomposing device (180) is installed at the aforementioned wasted ozone outlet (171).

The aforementioned wasted ozone discomposing reaction device (180) is the cylinder reactor having inlet and outlet, and the ultraviolet lamp protected by quartz tube is located at the center, and the photo-catalyst carrier having titanium dioxide as main ingredient is filled around the quartz tube. The not reacted ozone is discomposed by photo-oxidation as it is passing through the photo-catalyst layer illuminated with the ultraviolet rays.

Generally, the ozone is generated by UV-C less than 200 nm but the ozone can be discomposed effectively if the characteristics that the ozone is discomposed by photo-catalyst illuminated with ultraviolet ray are used.

If the gas-liquid reactor (110) is connected in series as shown in FIG. 3, since the ozone passed through primary reaction and the pollutants are passing same reaction as primary the gas-liquid reactor (110) in the secondary gas-liquid reactor (120) and tertiary gas-liquid reactor (130), there is any difference except that the reaction is occurred in a lowered ozone concentration whenever the ozone is passing each the gas-liquid reactor (110, 120, 130), and the volume of not reacted ozone can be reduced considerably by occurring reaction repeatedly as the ozone gas is passing the various gas-liquid reactors, for which the ozone efficiency is increased, and the pollutant removal efficiency is increased, too.

In addition, the DOF process, which the not reacted ozone is reacted again with pollutants in the treated water by injecting the treated water in the pressurized state into the bottom of gas-liquid separator, and making the micro- or nano-sized fine ozone bubbles to float in the treated water, can be applied.

The aforementioned wasted ozone discomposing device connected to the outlet (1710 of the gas-liquid separator (170) is the cylinder type reactor where the ultraviolet lamp protected by quartz tube is located at the center, and the photo-catalyst having titanium dioxide as main ingredient is charged around the quartz tube, and the not reacted ozone is discomposed by photo-oxidation into the harmless oxygen and discharged to the atmosphere as the not reacted ozone is passing the layer of photo-catalyst illuminated with ultraviolet ray.

In addition, the AOP (Advanced Oxidation Process), which discompose the non-biodegradable pollutants hardly discomposed by the oxidation power of ozone, by the OH-radical (Hydroxy radical) generated by photo-catalyst reaction of the not-reacted-ozone and ultraviolet as the treated water passes the photo-catalyst layer illuminated with ultraviolet ray by attaching the advanced oxidation reactor, which is the cylinder type reactor having inlet and outlet, the ultraviolet lamp protected by quartz tube in the center, and charged with photo-catalyst having titanium dioxide as main ingredient around the quartz tube, at the front end of the inlet (172) of the aforementioned gas-liquid separator, can be grafted to eliminate the not-reacted ozone and pollutants additionally by increasing pollutant removal efficiency.

In the following section, the application examples on the water treatment methods by applying gas collecting gas-liquid reactor designed by this invention, shall be explained.

### Application Example 1

The method to reuse the water as heavy water by treating effluence to be used as urban river water, agricultural water, industrial water, heavy water for building, etc. by eliminating odor, color, microbes from the effluence of the sewage treatment plant and the wasted water treatment plant where the polluted water are purified under the environmental standard with the biological treatment method using ozone gas collecting gas-liquid reactor and discharged.

### Application Example 2

The method for the water treatment plant having stream water as water supply sources to treat the diverse non-biodegradable pollutants flowed into the water treatment plant such as the 1,4-dioxane, etc. which cannot be treated well by existing water treatment methods by the increase of the new substances and increased water pollution by the industrial development using aforementioned ozone gas collecting gas-liquid reactor.

### Application Example 3

The method to purify the polluted gas with the ozone gas collecting gas-liquid reactor using polluted gas instead of ozone, and the purification solution instead of polluted water instead of using existing polluted gas purification equipment, which the polluted gas is injected from the bottom and the purification solution from the top

### Application Example 4

The method to treat the non-biodegradable pollutants, which are not discomposed well with biological treatments, by increasing reflux ratio of the polluted water or injecting highly concentrated ozone using the ozone gas collecting gas-liquid reactor designed by this invention.

### Application Example 5

The method to increase the separation membrane treatment efficiency by installing the ozone gas collecting gas-liquid reactor designed by this invention at the front end of the process to treat the polluted water using separation membrane like reverse osmosis membrane.

### Possibility to be Use in Industry

This invention having aforementioned structure provides the gas collecting gas-liquid reactor to be able be reduce the costs such as installation cost and operating cost of the water treatment equipment and the gas purification equipment by increasing the contact time between the gas and liquid and their reaction efficiency.

1. A gas collecting gas-liquid reactor in which a collecting space is formed vertically inside and having the inlet at the top and outlet at the bottom linked to the top and bottom of the aforementioned collecting space, the gas collecting gas-liquid reactor being characterized in that the gas and liquid are pressurized to 1 to 15 atmosphere pressure, injected through the inlet at the top, the gas being collected from the top of the aforementioned collecting space filling toward the bottom in sequence, and discharging through the outlet at the bottom, and the liquid being sprayed from the inlet at the top and performing catalyst reaction with the gas collected in the gas layer in the collecting space, and being discharged through the outlet at the bottom.

2. The reactor of claim 1, wherein the multiple units of the aforementioned gas-liquid reactor are connected in series or in parallel.

3. A water treatment equipment comprising:
a gas collecting gas-liquid reactor, the reactor being characterized in that a collecting space is formed vertically inside and having the inlet at the top and outlet at the bottom linked to the top and bottom of the aforementioned collecting space and the gas-liquid separator connected to the aforementioned outlet at the bottom of the aforementioned gas-liquid reactor, the gas-liquid reactor being constructed that the reactor pressurizes the gas and liquid to 1 to 15 atmosphere pressure, injects through the inlet at the top, the gas being collected from the top of the aforementioned collecting space filling toward the bottom in sequence, and discharging through the outlet at the bottom, and the liquid being sprayed from the inlet at the top and perform catalyst reaction with the gas collected in the gas layer in the collecting space, and being discharged through the outlet at the bottom, and the aforementioned gas-liquid separator to separate the non-reacted ozone from the treated water removing the pressure of the pressurized treated water.

4. The equipment of claim 3, wherein the filling material composed of one or more materials out of metal, ceramic, high polymer resin is charged in the aforementioned collecting space.

5. The equipment of claim 3, further comprising:
a wasted ozone discomposing device connected to the outlet of the aforementioned gas-liquid separator in order to reduce the not-reacted ozone discharged from aforementioned gas-liquid separator and disposed, and using the aforementioned gas-liquid reactor, the wasted ozone discomposing device being characterized in that the aforementioned wasted ozone discomposing device is the cylinder type reactor constructed including inlet, outlet, the quartz tube, in which the ultraviolet lamp is inserted and protected, and the ultraviolet charged around the aforementioned quartz tube and the photo-catalyst using the titanium dioxide in order to treat the not-reacted ozone and not-reacted pollutants by the advanced oxidation process, which converts the not-reacted ozone into OH radical and eliminated the pollutants reacting with Oh radical.

6. A gas purification equipment comprising:
a gas-liquid reactor in which a collecting space is formed vertically inside and having the inlet at the top and outlet at the bottom linked to the top and bottom of the aforementioned collecting space and the gas-liquid separator connected to the aforementioned outlet at the bottom of the aforementioned gas-liquid reactor, the aforementioned gas-liquid reactor being characterized in that the reactor pressurizes the gas and liquid to 1 to 15 atmosphere pressure by booster pump, injects through the inlet at the top, the gas being collected from the top of the aforementioned collecting space filling the space toward the bottom in sequence, and discharging through the outlet at the bottom, and the liquid being sprayed from the inlet at the top and performing catalyst reaction with the gas collected in the gas layer in the collecting space, and being discharged through the outlet at the bottom, but the gas being the polluted gas contained the pollutants and the aforementioned liquid of the purification solution,
wherein the aforementioned polluted gas is collected from the top of the aforementioned collecting space filling the space toward the bottom to the aforementioned outlet at the bottom, and
wherein the aforementioned purification solution is sprayed from the inlet at the top and performs the catalyst reaction with the gas collected in the gas layer in the collecting space falling down, and discharged through the outlet at the bottom together with the purified gas.

7. The equipment of claim 4, further comprising:
a wasted ozone discomposing device connected to the outlet of the aforementioned gas-liquid separator in order to reduce the not-reacted ozone discharged from aforementioned gas-liquid separator and disposed, and using the aforementioned gas-liquid reactor, the wasted ozone discomposing device being characterized in that the aforementioned wasted ozone discomposing device is the cylinder type reactor constructed including inlet, outlet, the quartz tube, in which the ultraviolet lamp is inserted and protected, and the ultraviolet charged around the aforementioned quartz tube and the photo-catalyst using the titanium dioxide in order to treat the not-reacted ozone and not-reacted pollutants by the advanced oxidation process, which converts the not-reacted ozone into OH radical and eliminated the pollutants reacting with Oh radical.
